(19) United States
(12) Patent Application Publication
(10) Pub. No.: US 2026/0024418 A1
(43) Pub. Date: Jan. 22, 2026

(54) PERSISTENT REEL CROSSING BONUS

(71) Applicant: IGT, Las Vegas, NV (US)

(72) Inventors: Nathan AJHAR, Sparks, NV (US); Nicholas HILLSTROM, Reno, NV (US); Lauren HILLSTROM, Reno, NV (US); Yu CHONG, Reno, NV (US)

(73) Assignee: IGT, Las Vegas, NV (US)

(21) Appl. No.: 18/773,813

(22) Filed: Jul. 16, 2024

(51) Int. Cl. G07F 17/34; G07F 17/32

(52) U.S. Cl. CPC G07F 17/34; G07F 17/3213; G07F 17/3244; G07F 17/3267

(57) ABSTRACT

An electronic gaming machine (“EGM”) can display a grid of symbols as part of a slot game. The EGM can further detect a triggering event as part of the slot game. The EGM can further, responsive to detecting the triggering event, determine that a non-symbol element is at a position relative to the grid of symbols. The EGM can further display the non-symbol element at the position.

### BACKGROUND

Embodiments described herein relate to operations of electronic gaming machines (“EGMs”). EGMs can provide one or more games (e.g., wagering games) stored therein that can be played by a player. The EGM can provide a prize to the player based on a wager and an outcome of a wagering game. An example of a wagering game includes a slot game in which, in response to receiving a wager from the player, one or more rows of symbols are revealed. A prize can be provided to the player based on the one or more rows of symbols including one or more winning combinations of symbols.

### SUMMARY

According to some embodiments, an electronic gaming machine (“EGM”) is provided. The EGM includes processing circuitry and memory coupled to the processing circuitry. The memory includes instructions stored therein that are executable by the processing circuitry to cause the EGM to perform operations. The operations include displaying a grid of symbols as part of a slot game. The operations further include detecting a triggering event as part of the slot game. The operations further include, responsive to detecting the triggering event, determining that a non-symbol element is at a position relative to the grid of symbols. The operations further include displaying the non-symbol element at the position.

According to other embodiments, a system is provided. The system includes processing circuitry and memory coupled to the processing circuitry. The memory includes instructions stored therein that are executable by the processing circuitry to cause the system to perform operations. The operations include determining a first grid of symbols that comprises a first plurality of symbols. The operations further include determining a position relative to the grid of symbols of a non-symbol element. The operations further include displaying a first play of a slot game comprising the first grid of symbols and the non-symbol element. The operations further include, subsequent to displaying the first play of the slot game, determining a second grid of symbols that comprises a second plurality of symbols. The operations further include determining whether to move, maintain, or remove the non-symbol element as part of a second play of the slot game. The operations further include displaying the second play of the slot game comprising the second grid of symbols and based on determining whether to move, maintain, or remove the non-symbol element.

According to other embodiments, a method is provided. The method includes displaying a grid of symbols as part of a slot game. The method further includes displaying a non-symbol element at a position relative to the grid of symbols. The method further includes outputting a reward associated with the slot game based on the position of the non-symbol element.

According to other embodiments, EGMs, systems, methods, and non-transitory computer-readable medium are provided for performing the above embodiments.

### BRIEF DESCRIPTION OF THE DRAWINGS

FIG. 1 is a schematic block diagram illustrating an example of a network configuration for a plurality of gaming devices according to some embodiments;

FIGS. 2A-E are diagrams illustrating examples of gaming devices according to some embodiments;

FIGS. 3A-D are schematic diagrams illustrating examples of a slot game with a persistent non-symbol element crossing the reels based on occurrence of a symbol according to some embodiments;

FIGS. 4A-D are schematic diagrams illustrating examples of a slot game with a persistent non-symbol element horizontally crossing the reels based on occurrence of a non-symbol according to some embodiments;

FIGS. 5A-F are schematic diagrams illustrating examples of a slot game with a persistent non-symbol element vertically and horizontally crossing the reels based on occurrence of a non-symbol according to some embodiments;

FIG. 6 is a schematic diagram illustrating an example of a slot game with a persistent non-symbol element cand corresponding counters based on occurrence of a symbol according to some embodiments; and

FIG. 7 is a flow chart illustrating an example of operations performed by an EGM and/or gaming system according to some embodiments.

### DETAILED DESCRIPTION

Electronic gaming machines (“EGMs”) can attract and retain players by offering the opportunity to win prizes. However, players can become bored with repetitive game design and mechanics.

Various embodiments herein describe methods for allowing a non-symbol element to provide an additional aspect of a wagering game. In some examples, the non-symbol element can be persistent (e.g., present across multiple plays of the slot game) and affect each play of the slot game based on its position. In additional or alternative examples, the persistent element can make its way across the reels based on one or more outcomes of the slot games or based on the occurrence of additional non-symbol elements. In additional or alternative examples, in response to the persistent element reaching a specific position, the persistent element can trigger a bonus.

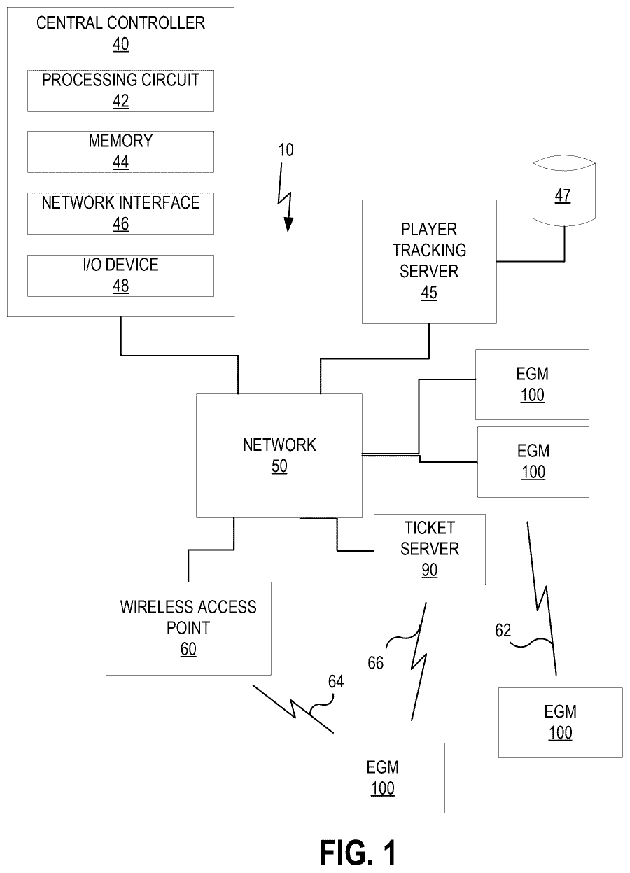

Before describing these and other embodiments in detail, reference is made to FIG. 1, which illustrates a gaming system 10 including a plurality of gaming devices 100. As discussed above, the gaming devices 100 may be one type of a variety of different types of gaming devices, such as electronic gaming machines (EGMs), mobile devices, or other devices, for example. The gaming system 10 may be located, for example, on the premises of a gaming establishment, such as a casino. The gaming devices 100, which are typically situated on a casino floor, may be in communication with each other and/or at least one central controller 40 through a data communication network 50 that may include a remote communication link. The central controller 40 can include processing circuit 42, memory 44, network interface 46, and an input/output (“I/O”) device 48. In some examples, the memory 44 includes instructions executable by processing circuit 42 for causing the central controller 40 to perform operations. The operations can include communicating with the data communication network 50 via the network interface 46 and/or communicating with a user/operator via the I/O device 48.

The data communication network 50 may be a private data communication network that is operated, for example, by the gaming facility that operates the gaming devices 100. Communications over the data communication network 50 may be encrypted for security. The central controller 40 may be any suitable server or computing device which includes at least one processor circuit and at least one memory or storage device. Each gaming device 100 may include a processor circuit that transmits and receives events, messages, commands or any other suitable data or signal between the gaming device 100 and the central controller 40. The gaming device processor circuit is operable to execute such communicated events, messages or commands in conjunction with the operation of the gaming device 100. Moreover, the processor circuit of the central controller 40 is configured to transmit and receive events, messages, commands or any other suitable data or signal between the central controller 40 and each of the individual gaming devices 100. In some embodiments, one or more of the functions of the central controller 40 may be performed by one or more gaming device processor circuits. Moreover, in some embodiments, one or more of the functions of one or more gaming device processor circuits as disclosed herein may be performed by the central controller 40.

A wireless access point 60 provides wireless access to the data communication network 50. The wireless access point 60 may be connected to the data communication network 50 as illustrated in FIG. 1, and/or may be connected directly to the central controller 40 or another server connected to the data communication network 50.

A player tracking server 45 may also be connected through the data communication network 50. The player tracking server 45 may manage a player tracking account that tracks the player's gameplay and spending and/or other player preferences and customizations, manages loyalty awards for the player, manages funds deposited or advanced on behalf of the player, and other functions. Player information managed by the player tracking server 45 may be stored in a player information database 47.

As further illustrated in FIG. 1, the gaming system 10 may include a ticket server 90 that is configured to print and/or dispense wagering tickets. The ticket server 90 may be in communication with the central controller 40 through the data communication network 50. Each ticket server 90 may include a processor circuit that transmits and receives events, messages, commands or any other suitable data or signal between the ticket server 90 and the central controller 40. The ticket server 90 processor circuit may be operable to execute such communicated events, messages or commands in conjunction with the operation of the ticket server 90. Moreover, in some embodiments, one or more of the functions of one or more ticket server 90 processor circuits as disclosed herein may be performed by the central controller 40.

The gaming devices 100 communicate with one or more elements of the gaming system 10 to coordinate providing wagering games and other functionality. For example, in some embodiments, the gaming device 100 may communicate directly with the ticket server 90 over a wireless interface 62, which may be a WiFi link, a Bluetooth link, an NFC link, etc. In other embodiments, the gaming device 100 may communicate with the data communication network 50 (and devices connected thereto, including other gaming devices 100) over a wireless interface 64 with the wireless access point 60. The wireless interface 64 may include a WiFi link, a Bluetooth link, an NFC link, etc. In still further embodiments, the gaming devices 100 may communicate simultaneously with both the ticket server 90 over the wireless interface 66 and the wireless access point 60 over the wireless interface 64. Some embodiments provide that gaming devices 100 may communicate with other gaming devices over a wireless interface 64. In these embodiments, wireless interface 62, wireless interface 64 and wireless interface 66 may use different communication protocols and/or different communication resources, such as different frequencies, time slots, spreading codes, etc.

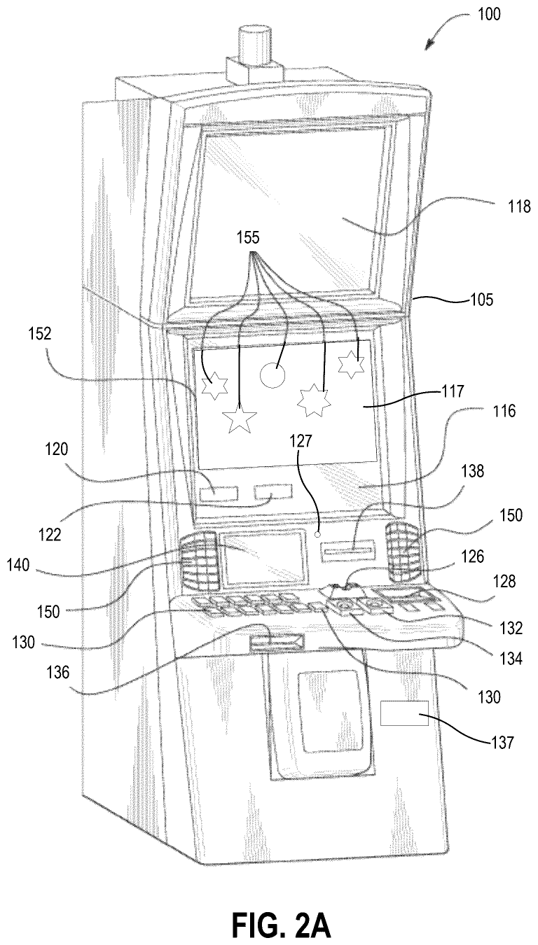

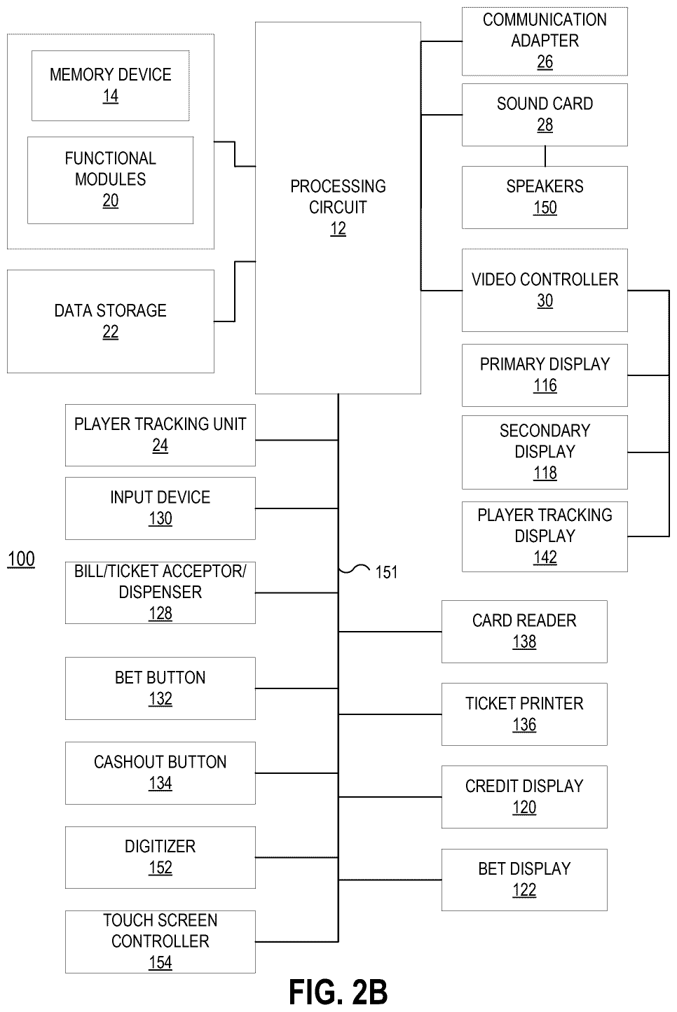

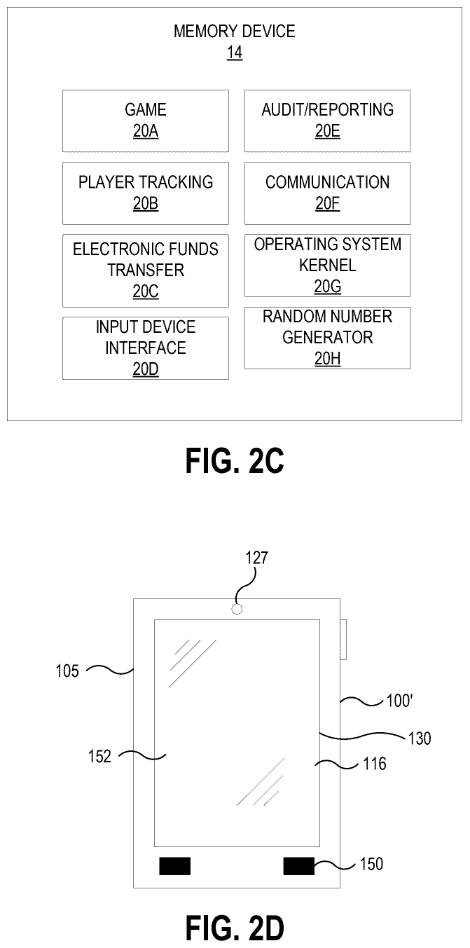

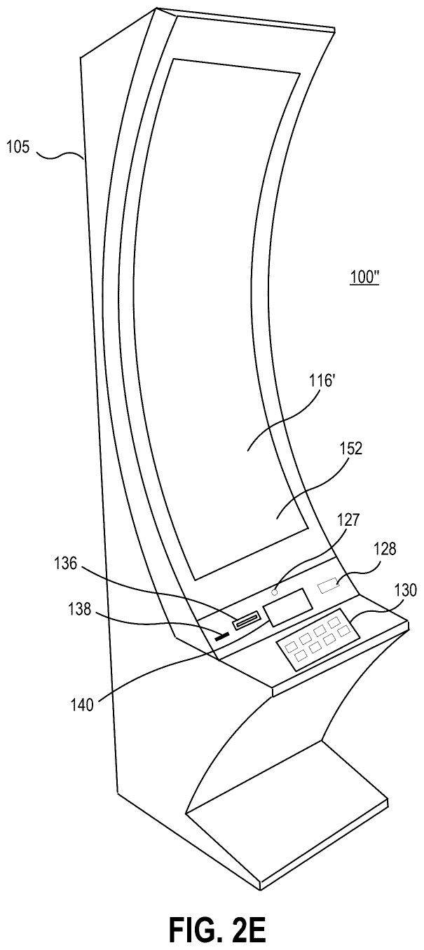

Embodiments herein may include different types of gaming devices. Various embodiments are illustrated in FIGS. 2A-2C in which FIG. 2A is a perspective view of a gaming device 100 illustrating various physical features of the device, FIG. 2B is a functional block diagram that schematically illustrates an electronic relationship of various elements of the gaming device 100, and FIG. 2C illustrates various functional modules that can be stored in a memory device of the gaming device 100. The embodiments shown in FIGS. 2A-C are provided as examples for illustrative purposes only. It will be appreciated that gaming devices may come in many different shapes, sizes, layouts, form factors, and configurations, and with varying numbers and types of input and output devices, and that embodiments of the inventive concepts are not limited to the particular gaming device structures described herein.

Gaming devices 100 typically include a number of standard features, many of which are illustrated in FIGS. 2A-B. For example, referring to FIG. 2A, a gaming device 100 may include a support structure, housing 105 (e.g., cabinet) which provides support for a plurality of displays, inputs, outputs, controls and other features that enable a player to interact with the gaming device 100.

The gaming device 100 illustrated in FIG. 2A includes a number of display devices, including a primary display device 116 located in a central portion of the housing 105 and a secondary display device 118 located in an upper portion of the housing 105. A plurality of game components 155 are displayed on a display screen 117 of the primary display device 116. It will be appreciated that one or more of the display devices 116, 118 may be omitted, or that the display devices 116, 118 may be combined into a single display device. The gaming device 100 may further include a player tracking display 142, a credit display 120, and a bet display 122. The credit display 120 displays a player's current number of credits, cash, account balance or the equivalent. The bet display 122 displays a player's amount wagered. Locations of these displays are merely illustrative as any of these displays may be located anywhere on the gaming device 100.

The player tracking display 142 may be used to display a service window that allows the player to interact with, for example, their player loyalty account to obtain features, bonuses, comps, etc. In other embodiments, additional display screens may be provided beyond those illustrated in FIG. 2A. In some embodiments, one or more of the player tracking display 142, the credit display 120 and the bet display 122 may be displayed in one or more portions of one or more other displays that display other game related visual content. For example, one or more of the player tracking display 142, the credit display 120 and the bet display 122 may be displayed in a picture in a picture on one or more displays.

The gaming device 100 may further include a number of input devices 130 that allow a player to provide various inputs to the gaming device 100, either before, during or after a game has been played. The gaming device may further include a game play initiation button 132 and a cashout button 134. The cashout button 134 is utilized to receive a cash payment or any other suitable form of payment corresponding to a quantity of remaining credits of a credit display.

In some embodiments, one or more input devices of the gaming device 100 are one or more game play activation devices that are each used to initiate a play of a game on the gaming device 100 or a sequence of events associated with the gaming device 100 following appropriate funding of the gaming device 100. The example gaming device 100 illustrated in FIGS. 2A and 2B includes a game play activation device in the form of a game play initiation button 132. It should be appreciated that, in other embodiments, the gaming device 100 begins game play automatically upon appropriate funding rather than upon utilization of the game play activation device.

In some embodiments, one or more input device 130 of the gaming device 100 may include wagering or betting functionality. For example, a maximum wagering or betting function may be provided that, when utilized, causes a maximum wager to be placed. Another such wagering or betting function is a repeat the bet device that, when utilized, causes the previously placed wager to be placed. A further such wagering or betting function is a bet one function. A bet is placed upon utilization of the bet one function. The bet is increased by one credit each time the bet one device is utilized. Upon the utilization of the bet one function, a quantity of credits shown in a credit display (as described below) decreases by one, and a number of credits shown in a bet display (as described below) increases by one.

In some embodiments, as shown in FIG. 2B, the input device(s) 130 may include and/or interact with additional components, such as a touch-sensitive display that includes a digitizer 152 and a touchscreen controller 154 for touch input devices, as disclosed herein. The player may interact with the gaming device 100 by touching virtual buttons on one or more of the display devices 116, 118, 140. Accordingly, any of the above-described input devices, such as the input device 130, the game play initiation button 132 and/or the cashout button 134 may be provided as virtual buttons or regions on one or more of the display devices 116, 118, 140.

Referring briefly to FIG. 2B, operation of the primary display device 116, the secondary display device 118 and the player tracking display 142 may be controlled by a video controller 30 that receives video data from a processor circuit 12 or directly from a memory device 14 and displays the video data on the display screen. The credit display 120 and the bet display 122 are typically implemented as simple LCD or LED displays that display a number of credits available for wagering and a number of credits being wagered on a particular game. Accordingly, the credit display 120 and the bet display 122 may be driven directly by the processor circuit 12. In some embodiments however, the credit display 120 and/or the bet display 122 may be driven by the video controller 30. The gaming device 100 may also include a player tracking unit 24 for managing communications and functionality between the processor circuit 12 and certain peripherals and components. Player tracking units 24 may be standardized across machine types to operate interchangeably across a manufacturer's lineup.

Referring again to FIG. 2A, the display devices 116, 118, 140 may include, without limitation: a cathode ray tube, a plasma display, a liquid crystal display (LCD), a display based on light emitting diodes (LEDs), a display based on a plurality of organic light-emitting diodes (OLEDs), a display based on polymer light-emitting diodes (PLEDs), a display based on a plurality of surface-conduction electron-emitters (SEDs), a display including a projected and/or reflected image, or any other suitable electronic device or display mechanism. In certain embodiments, as described above, the display devices 116, 118, 140 may include a touchscreen with an associated touchscreen controller 154 and digitizer 152. The display devices 116, 118, 140 may be of any suitable size, shape, and/or configuration. The display devices 116, 118, 140 may include flat or curved display surfaces.

The display devices 116, 118, 140 and video controller 30 of the gaming device 100 are generally configured to display one or more game and/or non-game images, symbols, and indicia. In certain embodiments, the display devices 116, 118, 140 of the gaming device 100 are configured to display any suitable visual representation or exhibition of the movement of objects; dynamic lighting; video images; images of people, characters, places, things, and faces of cards; and the like. In certain embodiments, the display devices 116, 118, 140 of the gaming device 100 are configured to display one or more virtual reels, one or more virtual wheels, and/or one or more virtual dice. In other embodiments, certain of the displayed images, symbols, and indicia are in mechanical form. That is, in these embodiments, the display device 116, 118, 140 includes any electromechanical device, such as one or more rotatable wheels, one or more reels, and/or one or more dice, configured to display at least one or a plurality of game or other suitable images, symbols, or indicia.

The gaming device 100 also includes various features that enable a player to deposit credits in the gaming device 100 and withdraw credits from the gaming device 100, such as in the form of a payout of winnings, credits, etc. For example, the gaming device 100 may include a bill/ticket printer 136, a bill/ticket acceptor/dispenser 128, that allows the player to deposit and/or receive tickets and/or currency into the gaming device 100.

As illustrated in FIG. 2A, the gaming device 100 may also include a currency dispenser 137 that may include a note dispenser configured to dispense paper currency and/or a coin generator configured to dispense coins or tokens in a coin payout tray.

The gaming device 100 may further include one or more speakers 150 controlled by one or more sound cards 28 (FIG. 2B). The gaming device 100 illustrated in FIG. 2A includes a pair of speakers 150. In other embodiments, additional speakers, such as surround sound speakers, may be provided within or on the housing 105. Moreover, the gaming device 100 may include built-in seating with integrated headrest speakers.

In various embodiments, the gaming device 100 may generate dynamic sounds coupled with attractive multimedia images displayed on one or more of the display devices 116, 118, 140 to provide an audio-visual representation or to otherwise display full-motion video with sound to attract players to the gaming device 100 and/or to engage the player during gameplay. In certain embodiments, the gaming device 100 may display a sequence of audio and/or visual attraction messages during idle periods to attract potential players to the gaming device 100. The videos may be customized to provide any appropriate information.

The gaming device 100 may further include a card reader 138 that is configured to read magnetic stripe cards, such as player loyalty/tracking cards, chip cards, and the like. In some embodiments, a player may insert an identification card into a card reader of the gaming device. In some embodiments, the identification card is a smart card having a programmed microchip or a magnetic strip coded with a player's identification, credit totals (or related data) and other relevant information. In other embodiments, a player may carry a portable device, such as a cell phone, a radio frequency identification tag or any other suitable wireless device, which communicates a player's identification, credit totals (or related data) and other relevant information to the gaming device. In some embodiments, money may be transferred to a gaming device through electronic funds transfer. When a player funds the gaming device, the processor circuit determines the amount of funds entered and displays the corresponding amount on the credit or other suitable display as described above.

In some embodiments, the gaming device 100 may include an electronic payout device or module configured to fund an electronically recordable identification card or smart card or a bank or other account via an electronic funds transfer to or from the gaming device 100.

FIG. 2B is a block diagram that illustrates logical and functional relationships between various components of a gaming device 100. It should also be understood that components described in FIG. 2B may also be used in other computing devices, as desired, such as mobile computing devices for example. As shown in FIG. 2B, the gaming device 100 may include a processor circuit 12 that controls operations of the gaming device 100. Although illustrated as a single processor circuit, multiple special purpose and/or general-purpose processors and/or processor cores may be provided in the gaming device 100. For example, the gaming device 100 may include one or more of a video processor, a signal processor, a sound processor and/or a communication controller that performs one or more control functions within the gaming device 100. The processor circuit 12 may be variously referred to as a “controller,” “microcontroller,” “microprocessor” or simply a “computer.” The processor may further include one or more application-specific integrated circuits (ASICs).

Various components of the gaming device 100 are illustrated in FIG. 2B as being connected to the processor circuit 12. It will be appreciated that the components may be connected to the processor circuit 12 through a system bus 151, a communication bus and controller, such as a USB controller and USB bus, a network interface, or any other suitable type of connection.

The gaming device 100 further includes a memory device 14 that stores one or more functional modules 20. Various functional modules 20 of the gaming device 100 will be described in more detail below in connection with FIG. 2D.

The memory device 14 may store program code and instructions, executable by the processor circuit 12, to control the gaming device 100. The memory device 14 may also store other data such as image data, event data, player input data, random or pseudo-random number generators, pay-table data or information and applicable game rules that relate to the play of the gaming device. The memory device 14 may include random access memory (RAM), which can include non-volatile RAM (NVRAM), magnetic RAM (ARAM), ferroelectric RAM (FeRAM) and other forms as commonly understood in the gaming industry. In some embodiments, the memory device 14 may include read only memory (ROM). In some embodiments, the memory device 14 may include flash memory and/or EEPROM (electrically erasable programmable read only memory). Any other suitable magnetic, optical and/or semiconductor memory may operate in conjunction with the gaming device disclosed herein.

The gaming device 100 may further include a data storage 22, such as a hard disk drive or flash memory. The data storage 22 may store program data, player data, audit trail data or any other type of data. The data storage 22 may include a detachable or removable memory device, including, but not limited to, a suitable cartridge, disk, CD ROM, DVD or USB memory device.

The gaming device 100 may include a communication adapter 26 that enables the gaming device 100 to communicate with remote devices over a wired and/or wireless communication network, such as a local area network (LAN), wide area network (WAN), cellular communication network, or other data communication network. The communication adapter 26 may further include circuitry for supporting short range wireless communication protocols, such as Bluetooth and/or near field communications (NFC) that enable the gaming device 100 to communicate, for example, with a mobile communication device operated by a player.

The gaming device 100 may include one or more internal or external communication ports that enable the processor circuit 12 to communicate with and to operate with internal or external peripheral devices, such as eye tracking devices, position tracking devices, cameras, accelerometers, arcade sticks, bar code readers, bill validators, biometric input devices, bonus devices, button panels, card readers, coin dispensers, coin hoppers, display screens or other displays or video sources, expansion buses, information panels, keypads, lights, mass storage devices, microphones, motion sensors, motors, printers, reels, SCSI ports, solenoids, speakers, thumb drives, ticket readers, touch screens, trackballs, touchpads, wheels, and wireless communication devices. In some embodiments, internal or external peripheral devices may communicate with the processor circuit through a universal serial bus (USB) hub (not shown) connected to the processor circuit 12.

In some embodiments, the gaming device 100 may include a sensor, such as a camera 127, in communication with the processor circuit 12 (and possibly controlled by the processor circuit 12) that is selectively positioned to acquire an image of a player actively using the gaming device 100 and/or the surrounding area of the gaming device 100. In one embodiment, the camera 127 may be configured to selectively acquire still or moving (e.g., video) images and may be configured to acquire the images in either an analog, digital or other suitable format. The display devices 116, 118, 140 may be configured to display the image acquired by the camera 127 as well as display the visible manifestation of the game in split screen or picture-in-picture fashion. For example, the camera 127 may acquire an image of the player and the processor circuit 12 may incorporate that image into the primary and/or secondary game as a game image, symbol or indicia.

Various functional modules of that may be stored in a memory device 14 of a gaming device 100 are illustrated in FIG. 2C. Referring to FIG. 2C, the gaming device 100 may include in the memory device 14 a game module 20A that includes program instructions and/or data for operating a hybrid wagering game as described herein. The gaming device 100 may further include a player tracking module 20B, an electronic funds transfer module 20C, an input device interface 20D, an audit/reporting module 20E, a communication module 20F, an operating system kernel 20G and a random number generator 20H. The player tracking module 20B keeps track of the play of a player. The electronic funds transfer module 20C communicates with a back-end server or financial institution to transfer funds to and from an account associated with the player. The input device interface 20D interacts with input devices, such as the input device 130, as described in more detail below. The communication module 20F enables the gaming device 100 to communicate with remote servers and other gaming devices using various secure communication interfaces. The operating system kernel 20G controls the overall operation of the gaming device 100, including the loading and operation of other modules. The random number generator 20H generates random or pseudorandom numbers for use in the operation of the hybrid games described herein.

Many embodiments described herein employ gaming devices 100 that are land-based EGMs, such as banks of slot machines in a casino environment, but in some embodiments, a gaming device 100 may additionally or alternatively include a personal device, such as a desktop computer, a laptop computer, a mobile device, a tablet computer or computing device, a personal digital assistant (PDA), or other portable computing devices. In some embodiments, the gaming device 100 may be operable over a wireless network, such as part of a wireless gaming system. In such embodiments, the gaming machine may be a hand-held device, a mobile device or any other suitable wireless device that enables a player to play any suitable game at a variety of different locations. It should be appreciated that a gaming device or gaming machine as disclosed herein may be a device that has obtained approval from a regulatory gaming commission or a device that has not obtained approval from a regulatory gaming commission.

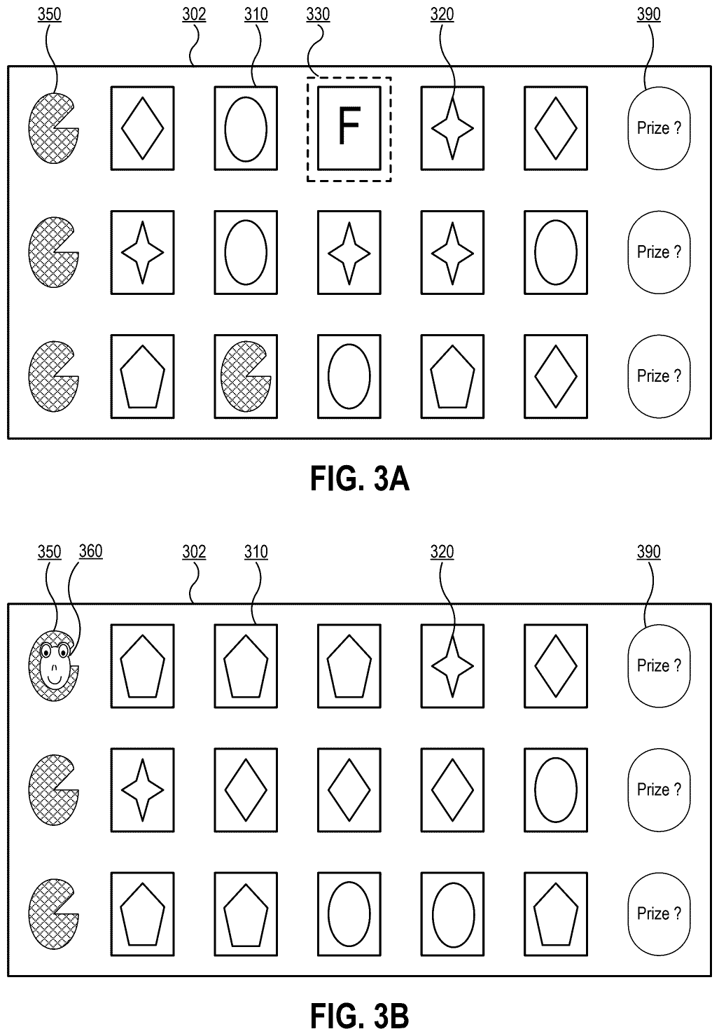

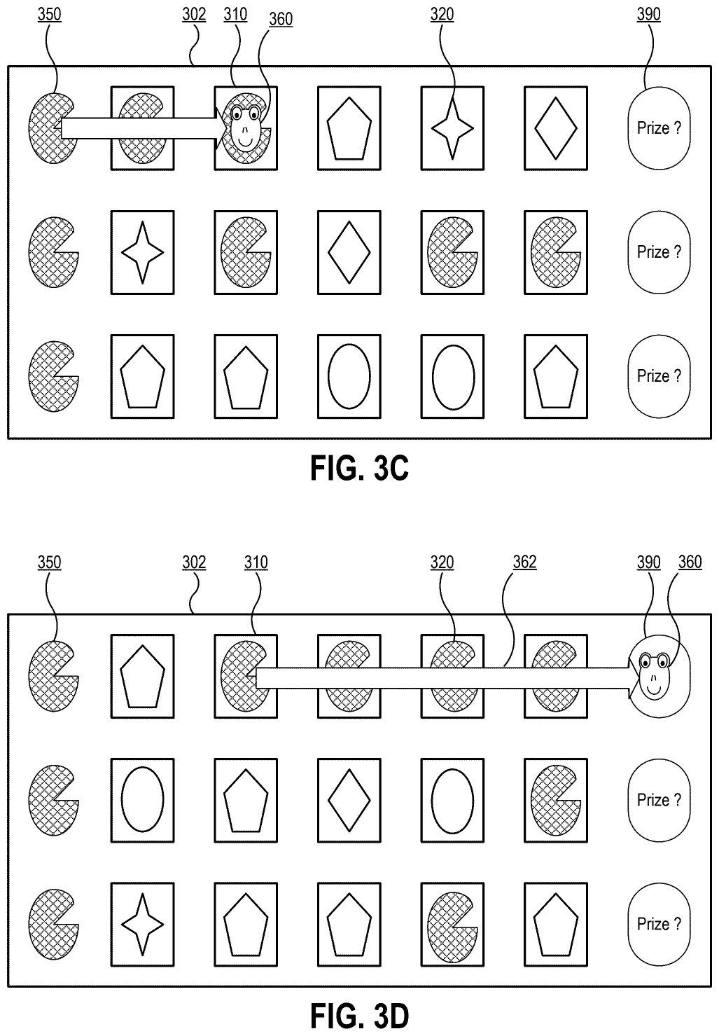

For example, referring to FIG. 2D, a gaming device 100′ may be implemented as a handheld device including a compact housing 105 on which is mounted a touchscreen display device 116 including a digitizer 152. As described in greater detail with respect to FIG. 3 below, one or more input devices 130 may be included for providing functionality of for embodiments described herein. A camera 127 may be provided in a front face of the housing 105. The housing 105 may include one or more speakers 150. In the gaming device 100′, various input buttons described above, such as the cashout button, gameplay activation button, etc., may be implemented as soft buttons on the touchscreen display device 116 and/or input device 130. In this embodiment, the input device 130 is integrated into the touchscreen display device 116, but it should be understood that the input device may also, or alternatively, be separate from the display device 116. Moreover, the gaming device 100′ may omit certain features, such as a bill acceptor, a ticket generator, a coin acceptor or dispenser, a card reader, secondary displays, a bet display, a credit display, etc. Credits can be deposited in or transferred from the gaming device 100′ electronically.

FIG. 2E illustrates a standalone gaming device 100″, i.e., an EGM in this example, having a different form factor from the gaming device 100 illustrated in FIG. 2A. In particular, the gaming device 100″ is characterized by having a large, high aspect ratio, curved primary display device 116′ provided in the housing 105, with no secondary display device. The primary display device 116′ may include a digitizer 152 to allow touchscreen interaction with the primary display device 116′. The gaming device 100″ may further include a player tracking display 142, an input device 130, a bill/ticket acceptor 128, a card reader 138, and a bill/ticket dispenser 136. The gaming device 100″ may further include one or more cameras 127 to enable facial recognition and/or motion tracking.

Although illustrated as certain gaming devices, such as electronic gaming machines (EGMs) and mobile devices, similar functions and/or operations as described herein may include wagering stations that may include electronic game tables, conventional game tables including those involving cards, dice and/or roulette, and/or other wagering stations such as sports book stations, video poker games, skill-based games, virtual casino-style table games, or other casino or non-casino style games. Further, gaming devices according to embodiments herein may be implemented using other computing devices and mobile devices, such as smart phones, tablets, and/or personal computers, among others.

Various embodiments herein describe operations for allowing a non-symbol element to provide an additional aspect of a wagering game. In some examples, the non-symbol element can be persistent (e.g., present across multiple plays of the slot game) and affect each play of the slot game based on its position. In additional or alternative examples, the persistent element can make its way across the reels based on one or more outcomes of the slot games or based on the occurrence of additional non-symbol elements. In additional or alternative examples, in response to the persistent element reaching a specific position, the persistent element can trigger a bonus.

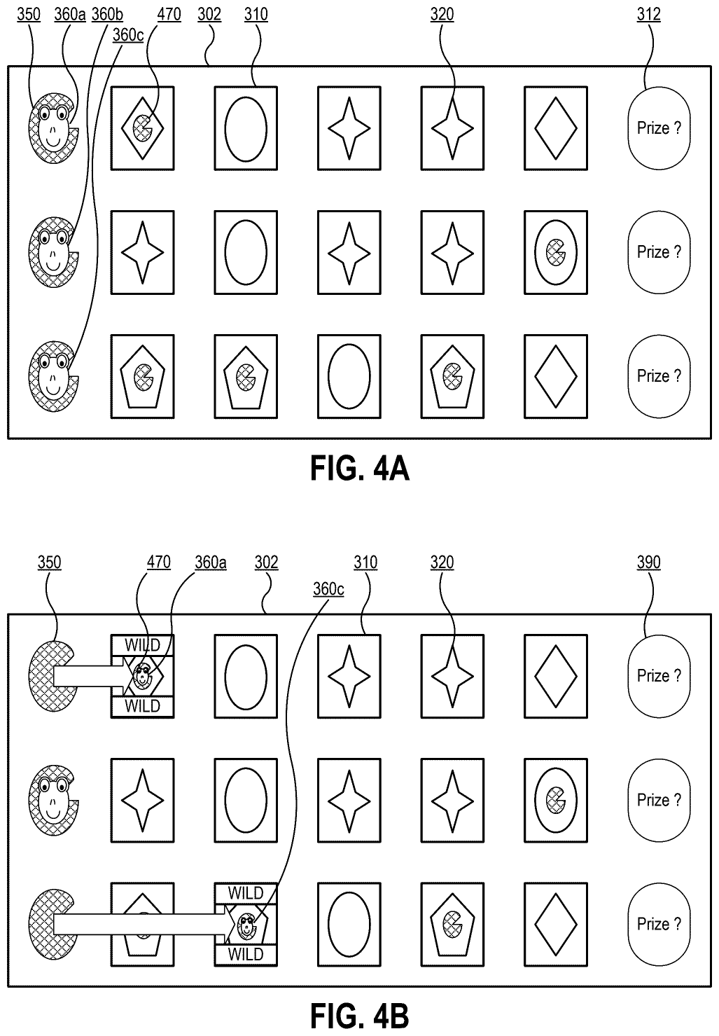

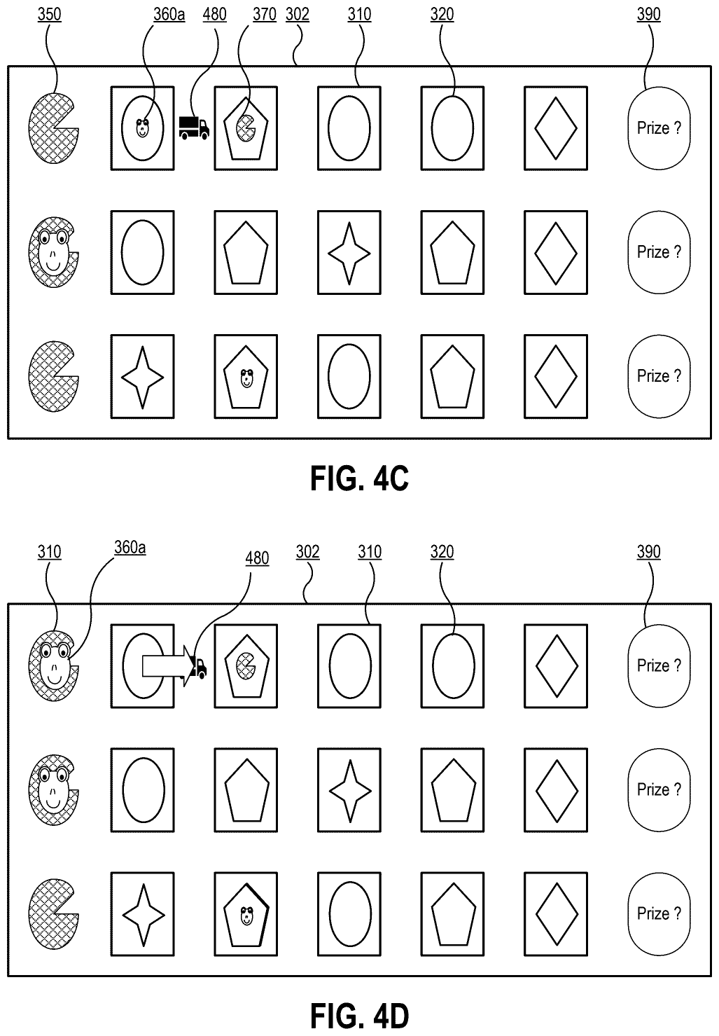

Embodiments herein may be described (and illustrated) with a frog theme, in which a non-symbol element (represented by a frog) attempts to cross a series of reels by moving to lily pads (which may be symbols as in FIGS. 3A-D or non-symbols as in FIGS. 4A-D). However, various themes (e.g., graphical, auditory, or haptic elements) may be used to illustrate the persistent element as it changes positions relative to the grid of symbols. Although many embodiments herein will describe the non-symbol element traveling from left to right across the reels, different embodiments may include a non-symbol element traveling in a different direction (e.g., right to left or up to down).

FIGS. 3A-D illustrate an example of a set of display outputs as part of a slot game. In these examples, a series of symbols 320 are displayed at various symbol positions 310 that form a grid of symbols 302. The display further includes a set of starting points 350 (illustrated as lily pads to the left of the grid of symbols) for non-symbol elements 360 (illustrated as frogs) to be initiated on and a set of prizes 390 (or bonuses) that may be won in response to a non-symbol element 360 reaching a position associated with the corresponding prize 390.

FIG. 3A illustrates a display output as part of a first spin of a slot game. The display output includes a triggering event 330. In this example, the triggering event is the occurrence of an “F” symbol among the grid of symbols. As a result, in FIG. 3B (which illustrates a display output as part of a second spin or a second play of the slot game) a non-symbol element 360 (a frog) is initialized on a starting position 350 (a lily pad). Here, the non-symbol element 360 is initialized on a starting position 350 that is in the same row that the triggering event occurred in FIG. 3A. In other examples, there may be a single starting spot 350 associated with each row of symbols 320. In additional or alternative examples, the starting spot 350 may be associated with a symbol position 310 in which the triggering event 330 occurred.

FIG. 3C illustrates a display output as part of a third spin or a third play of the slot game. The non-symbol element 360 (which has persisted across the independent spins/plays of the slot game) has moved to the symbol position 310 in the first row and second column of the grid of symbols 302 based on there being a specific type of symbol 320 (here lily pads) in the first two symbol positions 310 of the top row of the grid of symbols 302. Here, the non-symbol element 360 has moved across two symbol positions 310 and is limited to only moving within a single row of the grid of symbols 302.

In some examples, the non-symbol 360 may have a limited number of moves per-spin. The number of moves may be predetermined based on a type of game, a wager amount, or a player loyalty level. In additional or alternative examples, the non-symbol 360 can move vertically within a column or diagonally from one row/column pair to another row/column pair in response to the specific symbol 320 (lily pad) being at the destination (and along the path taken).

FIG. 3D illustrates a display output as part of a fourth spin or a fourth play of the slot game. The non-symbol element 360 (which has persisted across the independent spins/plays of the slot game) has moved to the position of the prize 390 adjacent to the first row in the grid of symbols 302 based on there being a specific type of symbol 320 (here lily pads) in the final three symbol positions 310 of the top row of the grid of symbols 302. In some embodiments, as a result of the non-symbol element 360 reaching the position of the prize 390, the wagering game provides the player with a corresponding prize. In some examples, the prize is a static award. In additional or alternative examples, the prize is a multiplier that applies to the current or subsequent plays of the slot game. In additional or alternative examples, the prize is a bonus (e.g., free spins or a trigger for a bonus game).

In some embodiments, there are different types of non-symbol elements 360 that may be initialized based on different triggering events. The specific type of symbol 320 that allows the corresponding non-symbol element 360 to move across the grid of symbols 302 can be based on a type of the non-symbol element 360. For example, a game may include a King non-symbol element that can only move across king symbols and a Queen non-symbol element that can only move across queen symbols.

In additional or alternative embodiments, the symbol 320 at the same symbol position 310 as the non-symbol element 360 may be persistent. For example, a lily pad occupied b by a frog may persist until the frog moves from the lily pad.

In additional or alternative embodiments, the symbol 320 at the same symbol position 310 as the non-symbol element 360 may be modified (e.g., made wild). For example, a lily pad with a frog on it may become a wild.

FIGS. 4A-D illustrate another example of a series of display outputs as part of a slot game. Similar to FIGS. 3A-D, the display outputs illustrated in FIGS. 4A-D include a set of symbols 320 that are displayed at various symbol positions 310 that form a grid of symbols 302. The display further includes a set of starting points 350 (illustrated as lily pads to the left of the grid of symbols) for non-symbol elements 360 (illustrated as frogs) and a set of prizes 390 (or bonuses) that may be won in response to non-symbol element reaching a position associated with the corresponding prize 390.

However, in FIGS. 4A-D a non-symbol element can move across the reels based on non-symbol elements 470 (which will be referred to as “potential spots”) being positioned at symbol positions 310 within the grid of symbols 302. While still illustrated as lily pads, the potential spots 470 are not symbols and therefore do not prevent a symbol from being at the same symbol position 310. Furthermore, the potential spots 470 may be determined separately from the symbols 320. In some examples, an independent game function controls the occurrence and position of the potential positions 470.

In some embodiments, FIG. 4A illustrates a display output in which a series of non-symbol elements 360 are already initialized in the starting positions 350. In additional or alternative embodiments, the non-symbol elements 360 may be initialized to the starting positions 350 without a triggering event. In some examples, a non-symbol element 360 may always be displayed at one position within each row (e.g., at a starting position 350, at a symbol position 310 in the row, or at a prize 390 adjacent to the corresponding row). In additional or alternative examples, a new non-symbol element 360 may be displayed on a starting spot 350 in response to a previous non-symbol element 360 (that had been displayed on the starting spot 350) moving to a symbol position 310 in the grid of symbols 302.

FIG. 4B may illustrate a subsequent version of the same grid of symbols 302 in FIG. 4A. As illustrated non-symbol elements 360a and 360c have each moved to the right based on occurrence of the potential spots 470 (lily pads). The non-symbol element 360a has moved one symbol position 310 and the non-symbol element 360b has moved two symbol positions 310. In this example, in response to the non-symbol elements 360a and 360c being at the same symbol position 310 as potential spots 470 the symbol 320 at the symbol position 310 is made wild. The potential spots 470 may not be persistent (even if in the same symbol position 310) as a non-symbol element 360 such that the symbol 320 at the symbol position 310 may revert to its original type in a subsequent spin (as illustrated in FIG. 4C).

FIG. 4C illustrates a display output associated with a subsequent spin/play compared to FIG. 4B. In this example, a non-symbol element 480 (which will be referred to herein as a removal element) is displayed between the first symbol position 310 and the second symbol position of the first row of symbols. A removal element 480 can cause a non-symbol element 360a-c within the grid of symbols 302 to be removed (e.g., sent back to the starting points 350). Here, the removal element 480 is between two symbol positions 310 and will cause the removal of any non-symbol elements 360 that attempt to pass between the two symbol positions 310. Since the non-symbol element 360a is at the left symbol position 310 and a potential spot 370 is at the right symbol position 310 (and since the non-symbol element 360a is attempting to cross the reels from left to right), the non-symbol element 360a will attempt to move to the right symbol position 310 and be removed (as illustrated in FIG. 4D).

FIG. 4D illustrates a subsequent version of the same grid of symbols 302 in FIG. 4C. As illustrated non-symbol elements 360a has moved back to the starting point 350 in response to the non-symbol element 360a having attempted to move to its adjacent symbol position 310 while the removal element 480 was located between the symbol positions 310.

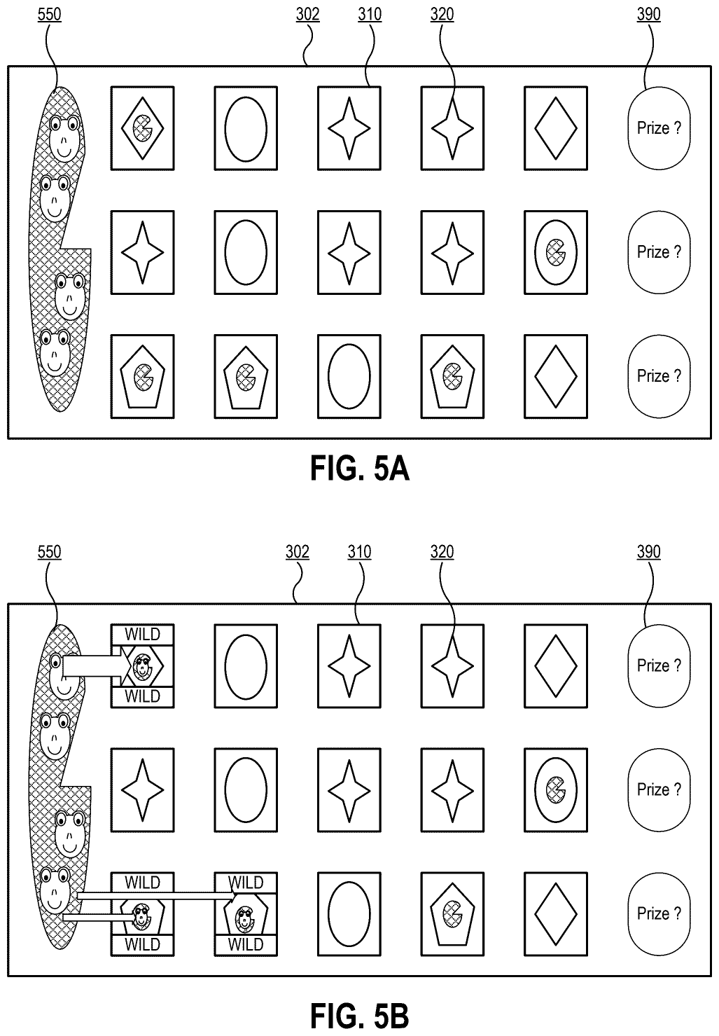

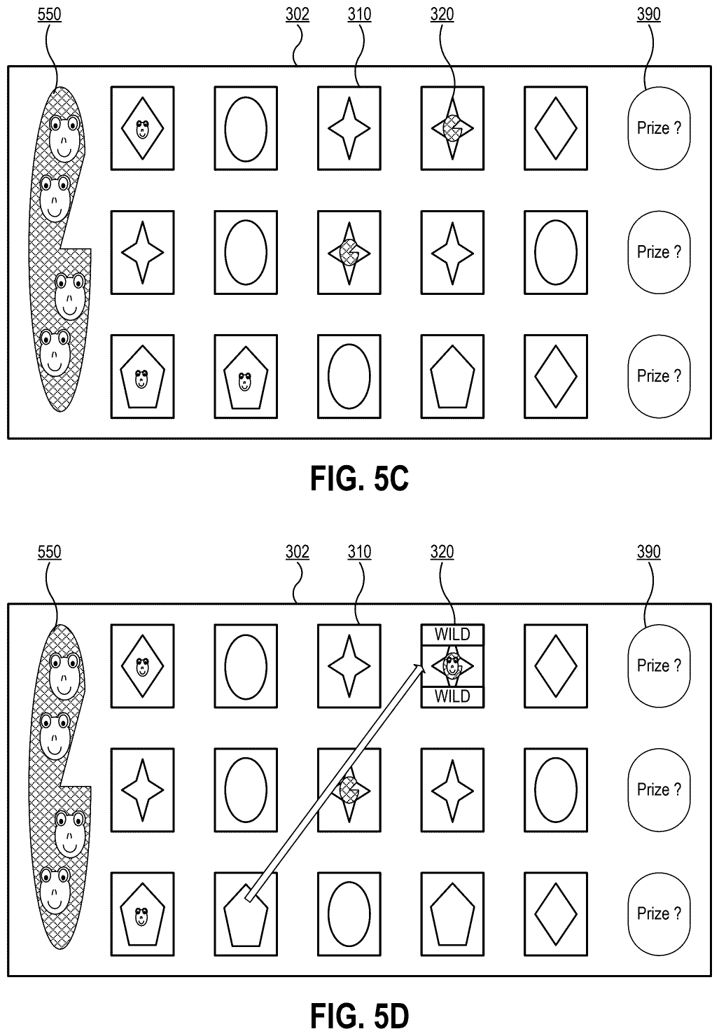

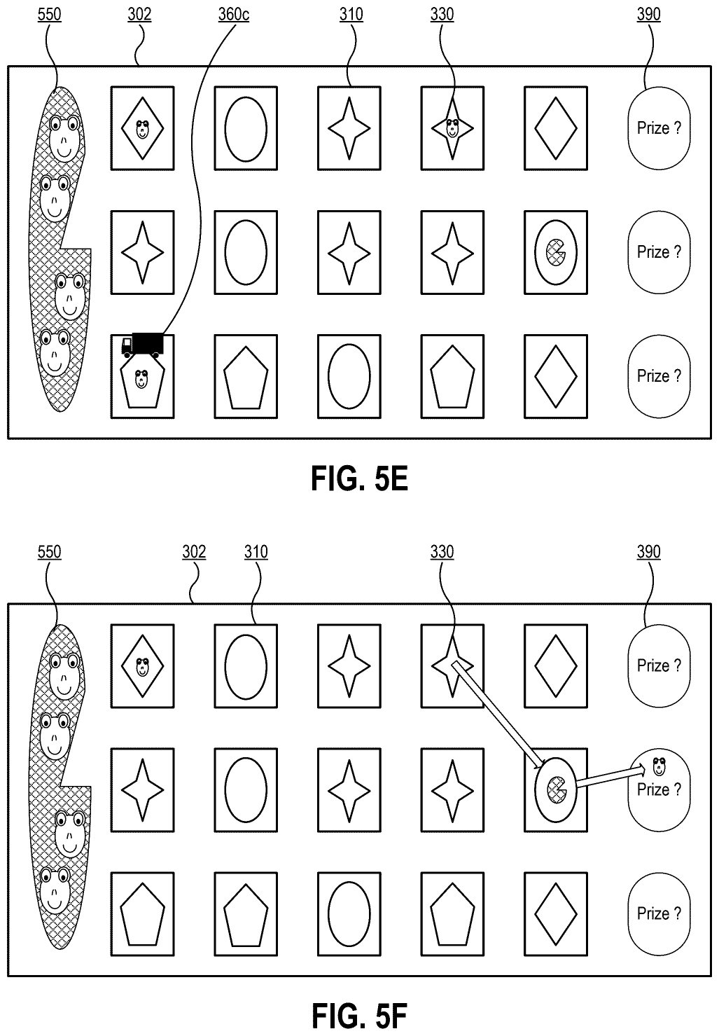

FIGS. 5A-F illustrate a different set of display outputs. In contrast to the starting points 350 of FIGS. 3A-D and 4A-D, FIGS. 5A-F illustrate a single starting point 550. In these examples, the non-symbol elements 360 are able to move horizontally (as illustrated in FIG. 5B) or diagonally (as illustrated in FIGS. 5D and 5F) from left to right in there are potential spots 370 along the path. As illustrated in FIG. 5B, only one non-symbol element 360 can occupy a symbol position 310, however, multiple non-symbol elements 360 can be move within the same row of symbol positions 310. As illustrated in FIG. 5D a removal element 580 can be positioned within a symbol position 310 (compared to between symbol positions 310 as in FIGS. 4C-D), which can result in the removal of any non-symbol elements 350 at the symbol position 310. In other examples, a removal element can affect an entire row or column.

The prizes 390 are illustrated with a “?” indicating that they are unknown. However, in some examples, the prizes 390 may be predetermined and displayed. In additional or alternative examples, the prizes 390 may be determined based upon initialization of a non-symbol element 360 and/or upon a non-symbol element 360 reaching a predetermined position (e.g., being half-way across the grid of symbols 302).

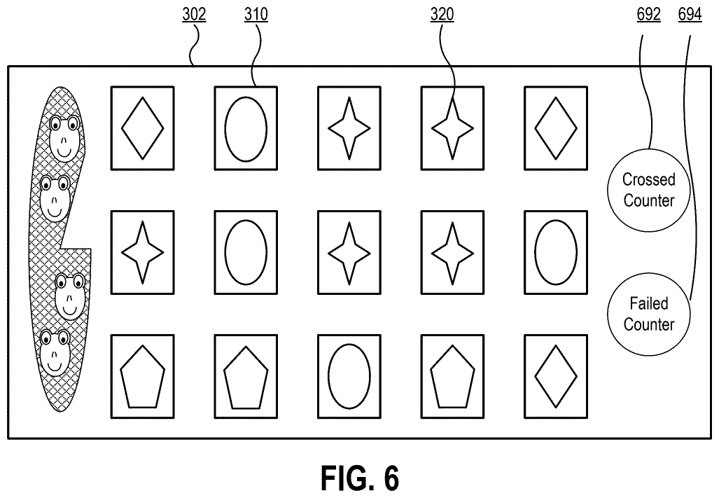

FIG. 6 illustrates an example of a display output including a crossed counter 692 and a roadkill counter 694 rather than prize positions. The crossed counter 692 can illustrate a number of non-symbol elements that have crossed the set of reels. The failed counter 694 can illustrate a number of non-symbol elements that have attempted, but failed to cross the set of reels (e.g., the number of road kill frogs). In some embodiments, a prize or bonus can be provided in response to the crossed counter 692 and/or the failed counter 694 exceeding a threshold number. In additional or alternative embodiments, gameplay associated with the grid of symbols and/or the non-symbol elements 360 may be modified based on a value of the crossed counter 692 and/or the failed counter 694.

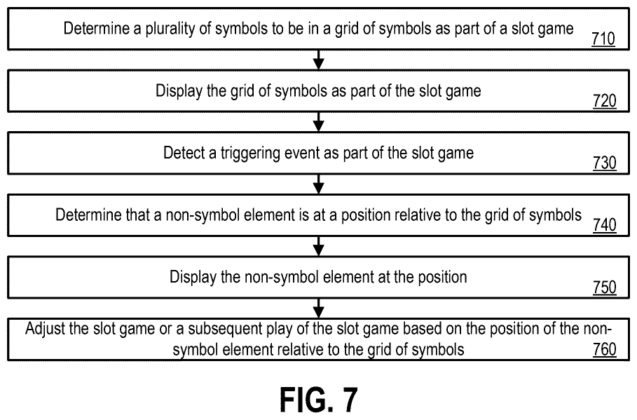

FIG. 7 illustrates an example of operations performed by an EGM according to some embodiments. Although the operations will be described in regards to processing circuit 12 and primary display 116 of EGM 100 of FIG. 2B, the operations can be performed by any suitable system, other elements of EGM 100, and/or by any suitable EGM.

At block 710, processing circuit 12 determines a plurality of symbols to be in a grid of symbols as part of a slot game. At block 720, processing circuit 12 displays, via primary display 116, the grid of symbols as part of the slot game. In some embodiments, the plurality of symbols are determined and displayed independently of any non-symbol elements positioned around or on the grid of symbols. In some examples, the persistent reel crossing elements described herein can be added to any reel game without modifying the underlying reel game.

At block 730, processing circuit 12 detects a triggering event as part of the slot game. In some embodiments, detecting the triggering event includes determining that the plurality of symbols includes a triggering symbol.

At block 740, processing circuit 12 determines that a non-symbol element is at a position relative to the grid of symbols. In some embodiments, the position of the non-symbol element is an initial (or first) position of the non-symbol element relative to the grid of symbols. In some examples, in response to a triggering event, the non-symbol element can be generated and displayed at a starting position.

In additional or alternative embodiments, the position of the non-symbol element is a second position of the non-symbol element relative to the grid of symbols. Determining the second position of the non-symbol element includes determining the second position of the non-symbol element based on a first position of the non-symbol element relative to the grid of symbols and a position within the grid of symbols of a trigger symbol associated with the trigger event.

In additional or alternative embodiments, the position of the non-symbol element is a second position of the non-symbol element relative to the grid of symbols. Determining the second position of the non-symbol element includes determining the second position of the non-symbol element based on a first position of the non-symbol element relative to the grid of symbols and a wager amount.

At block 750, processing circuit 12 displays, via primary display 116, the non-symbol element at the position. In some embodiments, the non-symbol element is displayed at a symbol position. In additional or alternative embodiments, the non-symbol element is displayed adjacent to a symbol position or between two or more symbol positions.

At block 760, processing circuit 12 adjusts the slot game or a subsequent play of the slot game based on the position of the non-symbol element relative to the grid of symbols. In some embodiments, adjusting the slot game or the subsequent play of the slot game includes determining a symbol in the grid of symbols based on the position of the non-symbol element; and replacing the symbol with a different symbol. In some examples, replacing the symbol with the different symbol includes replacing the symbol with a wild.

In additional or alternative embodiments, adjusting the slot game or the subsequent play of the slot game includes determining a prize based on a plurality of symbols within the grid of symbols and on the position of the non-symbol element relative to the grid of symbols; and providing the prize to a player of the slot game.

In additional or alternative embodiments, adjusting the slot game or the subsequent play of the slot game includes providing a free spin to a player of the slot game based on the position of the non-symbol element relative to the grid of symbols.

In some embodiments, the slot game is a second play of the slot game. In some examples, the grid of symbols is a second version of the grid of symbols that is part of the second play of the slot game and the trigger event is a second trigger event. The operations can further include displaying a first version of the grid of symbols as part of a first play of the slot game. The operations can further include detecting a first triggering event as part of the first play of the slot game. The operations can further include, responsive to detecting the first triggering event, determining that the non-symbol element is at the first position relative to the grid of symbols.

In some examples, the first position relative to the grid of symbols includes a position in a first reel of the grid of symbols. The second position relative to the grid of symbols includes a position in a second reel of the grid of symbols.

In additional or alternative examples, the operations further include determining a type of the non-symbol element based on a type of a first trigger symbol.

In additional or alternative examples, the first play of the slot game and the second play of the slot game are different spins associated with a single wager event.

In additional or alternative examples, the first play of the slot game and the second play of the slot game are each associated with a unique wager event.

In some embodiments, the non-symbol element is a first non-symbol element. The position relative to the grid of symbols is a first position relative to the grid of symbols and the triggering event is a first triggering event. In some examples, the operations further include detecting a second triggering event as part of the slot game. The operations can further include, responsive to detecting the second triggering event as part of the slot game, determining that a second non-symbol element is at a second position relative to the grid of symbols. The operations can further include displaying the second non-symbol element at the second position relative to the grid of symbols. The operations can further include responsive to the second position relative to the grid of symbols being with a threshold distance of the first position relative to the grid of symbols, eliminating the first non-symbol element and preventing the first non-symbol element from being displayed in a subsequent play of the slot game.

In some examples, the non-symbol element includes a virtual game element. Determining that the non-symbol element is at the position relative to the grid of symbols includes determining that the non-symbol element is at a starting position, at a position within the grid of symbols, or at a reward location.

Various operations from the flow chart of FIG. 7 may be optional with respect to some embodiments of EGMs and related methods.

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks. The flowchart and block diagrams in the FIGS. illustrate the architecture, functionality, and operation of possible implementations of systems, methods, and computer program products according to various aspects of the present disclosure. In this regard, each block in the flowchart or block diagrams may represent a module, segment, or portion of code, which includes one or more executable instructions for implementing the specified logical function(s). It should also be noted that, in some implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be designated as “/”. Like reference numbers signify like elements throughout the description of the figures.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

What is claimed is:

1. An electronic gaming machine, EGM, comprising:
processing circuitry; and
memory coupled to the processing circuitry and having instructions stored therein that are executable by the processing circuitry to cause the EGM to perform operations comprising:
displaying a grid of symbols as part of a slot game;
detecting a triggering event as part of the slot game;
responsive to detecting the triggering event, determining that a non-symbol element is at a position relative to the grid of symbols; and
displaying the non-symbol element at the position.

2. The EGM of claim 1, the operations further comprising:
determining a plurality of symbols to be in the grid of symbols as part of the slot game,
wherein detecting the triggering event comprises determining that the plurality of symbols comprises a triggering symbol.

3. The EGM of claim 1, the operations further comprising:
adjusting the slot game or a subsequent play of the slot game based on the position of the non-symbol element relative to the grid of symbols.

4. The EGM of claim 3, wherein adjusting the slot game or the subsequent play of the slot game comprises:
determining a symbol in the grid of symbols based on the position of the non-symbol element; and
replacing the symbol with a different symbol.

5. The EGM of claim 4, wherein replacing the symbol with the different symbol comprises replacing the symbol with a wild.

6. The EGM of claim 3, wherein adjusting the slot game or the subsequent play of the slot game comprises:
determining a prize based on a plurality of symbols within the grid of symbols and on the position of the non-symbol element relative to the grid of symbols; and
providing the prize to a player of the slot game.

7. The EGM of claim 3, wherein adjusting the slot game or the subsequent play of the slot game comprises providing a free spin to a player of the slot game based on the position of the non-symbol element relative to the grid of symbols.

8. The EGM of claim 1, wherein the position of the non-symbol element is a second position of the non-symbol element relative to the grid of symbols, and
wherein determining the second position of the non-symbol element comprises determining the second position of the non-symbol element based on a first position of the non-symbol element relative to the grid of symbols and a position within the grid of symbols of a trigger symbol associated with the trigger event.

9. The EGM of claim 1, wherein the position of the non-symbol element is a second position of the non-symbol element relative to the grid of symbols, and
wherein determining the second position of the non-symbol element comprises determining the second position of the non-symbol element based on a first position of the non-symbol element relative to the grid of symbols and a wager amount.

10. The EGM of claim 9, wherein the slot game is a second play of the slot game,
wherein the grid of symbols is a second version of the grid of symbols that is part of the second play of the slot game,
wherein the trigger event is a second trigger event,
the operations further comprising:
displaying a first version of the grid of symbols as part of a first play of the slot game;
detecting a first triggering event as part of the first play of the slot game; and
responsive to detecting the first triggering event, determining that the non-symbol element is at the first position relative to the grid of symbols.

11. The EGM of claim 10, wherein the first position relative to the grid of symbols comprises a position in a first reel of the grid of symbols, and
wherein the second position relative to the grid of symbols comprises a position in a second reel of the grid of symbols.

12. The EGM of claim 10, the operations further comprising:
determining a type of the non-symbol element based on a type of a first trigger symbol.

13. The EGM of claim 10, wherein the first play of the slot game and the second play of the slot game are different spins associated with a single wager event.

14. The EGM of claim 10, wherein the first play of the slot game and the second play of the slot game are each associated with a unique wager event.

15. The EGM of claim 1, wherein the non-symbol element is a first non-symbol element,
wherein the position relative to the grid of symbols is a first position relative to the grid of symbols, and
wherein the triggering event is a first triggering event,
the operations further comprising:
detecting a second triggering event as part of the slot game;
responsive to detecting the second triggering event as part of the slot game, determining that a second non-symbol element is at a second position relative to the grid of symbols; and
displaying the second non-symbol element at the second position relative to the grid of symbols.

16. The EGM of claim 15, the operations further comprising:
responsive to the second position relative to the grid of symbols being with a threshold distance of the first position relative to the grid of symbols, eliminating the first non-symbol element and preventing the first non-symbol element from being displayed in a subsequent play of the slot game.

17. The EGM of claim 1, wherein the non-symbol element comprises a virtual game element, and
wherein determining that the non-symbol element is at the position relative to the grid of symbols comprises determining that the non-symbol element is at a starting position, at a position within the grid of symbols, or at a reward location.

18. A system comprising:
processing circuitry; and
memory coupled to the processing circuitry and having instructions stored therein that are executable by the processing circuitry to cause the system to perform operations comprising:
determining a first grid of symbols that comprises a first plurality of symbols;
determining a position relative to the grid of symbols of a non-symbol element;
displaying a first play of a slot game comprising the first grid of symbols and the non-symbol element;
subsequent to displaying the first play of the slot game, determining a second grid of symbols that comprises a second plurality of symbols;
determining whether to move, maintain, or remove the non-symbol element as part of a second play of the slot game; and
displaying the second play of the slot game comprising the second grid of symbols and based on determining whether to move, maintain, or remove the non-symbol element.

19. The system of claim 18, wherein determining whether to move, maintain, or remove the non-symbol element as part of a second play of the slot game comprises determining to move the non-symbol element to a reward triggering position,
the operations further comprising:
providing a reward to a player of the slot game based on determining to move the non-symbol element to the reward triggering position.

20. A method comprising:
displaying a grid of symbols as part of a slot game;
displaying a non-symbol element at a position relative to the grid of symbols; and
outputting a reward associated with the slot game based on the position of the non-symbol element.
